(19) United States
(12) Patent Application Publication
(10) Pub. No.: US 2024/0289829 A1
(43) Pub. Date: Aug. 29, 2024

(54) REWARD CALCULATION DEVICE, REWARD CALCULATION METHOD, AND PROGRAM

(71) Applicant: HONDA MOTOR CO., LTD., Tokyo (JP)

(72) Inventors: Akinobu Hayashi, Wako-shi (JP); Naoki Morihira, Wako-shi (JP)

(21) Appl. No.: 18/536,317

(22) Filed: Dec. 12, 2023

(30) Foreign Application Priority Data
Feb. 24, 2023 (JP) 2023-026924

(51) Int. Cl. G06Q 30/0211

(52) U.S. Cl. CPC G06Q 30/0211

(57) ABSTRACT

A reward calculation device includes: an acquisition portion that acquires a state quantity of an apparatus which performs a task and a state quantity of a target object to which the task is performed; a storage portion that stores a subset of a plurality of state quantities used for an internal reward; a selection portion that selects, based on a selection criterion, one from the subset of the plurality of state quantities stored by the storage portion; a reward calculation portion that calculates the internal reward and an external reward by using the subset and the state quantity; and an update portion that updates the selection criterion of the subset of the state quantity based on the internal reward and the external reward.

### CROSS-REFERENCE TO RELATED APPLICATION

Priority is claimed on Japanese Patent Application No. 2023-026924, filed on Feb. 24, 2023, the contents of which are incorporated herein by reference.

### BACKGROUND

### Field of the Invention

The present invention relates to a reward calculation device, a reward calculation method, and a program.

### Background

In reinforcement learning, there is an approach of learning by using both an external reward for a task solution and an internal reward (preference for a rare situation or the like) that does not directly relate to a task solution (for example, refer to Japanese Unexamined Patent Application, First Publication No. 2019-192040). In machine learning, learning is repeated so as to maximize the reward.

### SUMMARY

However, in the related art, when performing an evaluation by using all of the state quantities or feature quantities at the time of calculating the internal reward, a search space may become large, and searching for situations that are entirely unrelated to the learning of the task solution may also occur. If a designer selects a feature quantity of calculating the internal reward in advance, information of the unselected feature quantity is lost.

An aspect of the present invention aims to provide a reward calculation device, a reward calculation method, and a program capable of improving a calculation efficiency when calculating an internal reward.

A reward calculation device according to a first aspect of the present invention is a reward calculation device in a learning apparatus that learns by using an external reward which is a reward for solving a given task and an internal reward which is a reward independent of a task, the reward calculation device including: an acquisition portion that acquires a state quantity of the apparatus which performs the task and a state quantity of a target object to which the task is performed; a storage portion that stores a subset of a plurality of state quantities used for the internal reward; a selection portion that selects, based on a selection criterion, one from the subset of the plurality of state quantities stored by the storage portion; a reward calculation portion that calculates the internal reward and the external reward by using the subset and the state quantity; and an update portion that updates the selection criterion of the subset of the state quantity based on the internal reward and the external reward.

A second aspect is the reward calculation device according to the first aspect described above, wherein the update portion may evaluate the external reward by using a multi-armed bandit model and update the selection criterion so as to select the internal reward used in the external reward having high evaluation.

A third aspect is the reward calculation device according to the first or second aspect described above, wherein the update portion may generate an action of the apparatus by probabilistically selecting one of a policy of the external reward and a policy of the internal reward associated with the subset of the state quantity, acquire the state quantity when the apparatus performs the generated action, and based on an acquired result, the selection criterion, and the external reward, select a policy of an internal reward associated with the subset of the state quantity used for calculation of the internal reward.

A fourth aspect is the reward calculation device according to any one of the first to third aspects described above, wherein the selection criterion may be any of a UCB value of a UCB (Upper Confidence Bound) method and a probability in a Thompson sampling method.

A fifth aspect of the present invention is a reward calculation method of a reward calculation device in a learning apparatus that learns by using an external reward which is a reward for solving a given task and an internal reward which is a reward independent of a task, the reward calculation method including: by way of an acquisition portion, acquiring a state quantity of the apparatus which performs the task and a state quantity of a target object to which the task is performed; by way of a storage portion, storing a subset of a plurality of state quantities used for the internal reward; by way of a selection portion, selecting, based on a selection criterion, one from the subset of the plurality of state quantities; by way of a reward calculation portion, calculating the internal reward and the external reward by using the subset and the state quantity; and by way of an update portion, updating the selection criterion of the subset of the state quantity based on the internal reward and the external reward.

A sixth aspect of the present invention is a computer-readable non-transitory recording medium including a program which causes a computer of a reward calculation device in a learning apparatus that learns by using an external reward which is a reward for solving a given task and an internal reward which is a reward independent of a task to: acquire a state quantity of the apparatus which performs the task and a state quantity of a target object to which the task is performed; store a subset of a plurality of state quantities used for the internal reward; select, based on a selection criterion, one from the subset of the plurality of state quantities; calculate the internal reward and the external reward by using the subset and the state quantity; and update the selection criterion of the subset of the state quantity based on the internal reward and the external reward. According to the first to sixth aspects described above, it is possible to improve the calculation efficiency when calculating the internal reward.

### BRIEF DESCRIPTION OF THE DRAWINGS

FIG. 1 is a view showing a multi-armed bandit model.

FIG. 2 is a view showing a configuration example of a reward calculation device according to an embodiment.

FIG. 3 is a view showing an outline of a process at the time of training of a manipulation method according to the embodiment.

FIG. 4 is a view showing an example of a subset according to the embodiment.

FIG. 5 is a flowchart of a process procedure at the time of learning by the reward calculation device according to the embodiment.

### DESCRIPTION OF EMBODIMENTS

Hereinafter, an embodiment of the present invention will be described with reference to the drawings. In the drawings used in the following description, the scale size of each member is appropriately changed such that each member is in a recognizable size.

In all of the drawings for describing the embodiment, the same reference numerals are used for components having the same function, and repetitive description is omitted.

Further, the term “based on XX” in the present application means “based on at least XX” and also includes the case based on another element in addition to XX. Further, the term “based on XX” is not limited to the case in which XX is directly used but also includes the case based on an element obtained by performing calculation or processing to XX. “XX” is an arbitrary element (for example, arbitrary information).

### (Outline)

In the related art, when performing evaluation by using all of state quantities (including feature quantities) at the time of calculating an internal reward, there is a problem that a search space may become large, and searching for situations that are entirely unrelated to learning of a task solution may also occur. Further, in the related art, if a designer selects a feature quantity of calculating the internal reward in advance, there is a problem that information of the unselected feature quantity is lost.

Therefore, in the present embodiment, in order not to explore all searches and not to fail to pick up various possibilities, a subset of a state quantity used for the internal reward is probabilistically selected from all state quantities. In the present embodiment, the selection probability of the state quantity is updated while considering the impact on an external reward. Thereby, in the present embodiment, a valid internal reward is selected without calculating all combinations.

### (Outline of Multi-Armed Bandit Model)

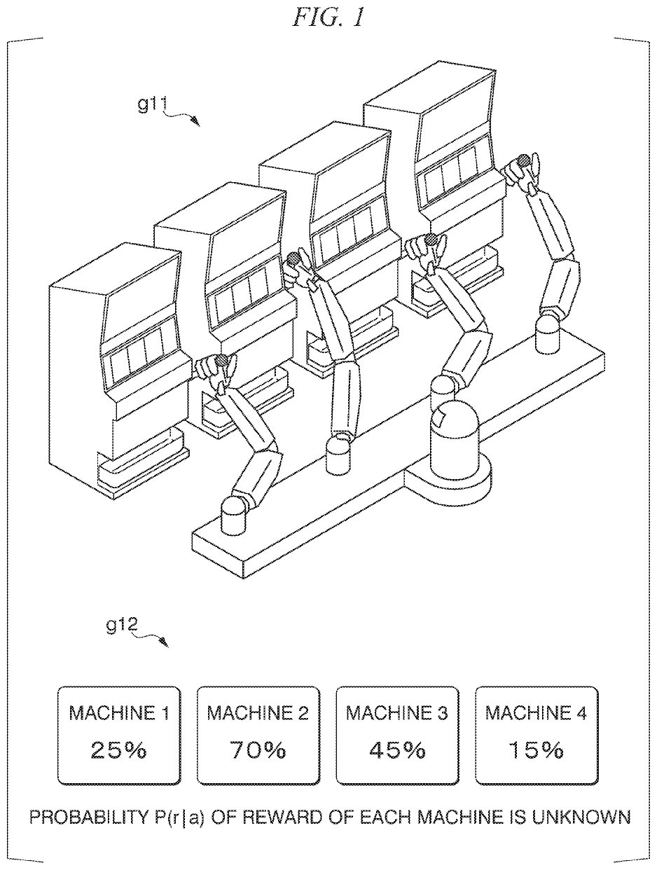

First, an outline of a multi-armed bandit model is described with reference to FIG. 1. FIG. 1 is a view showing a multi-armed bandit model.

The multi-armed bandit model is a problem of sequentially searching for the best one from candidates called as a plurality of arms. Some slot machines are given to a predictor, and the predictor can obtain a corresponding reward by operating each slot machine. However, the reward of each machine is unknown. It is a predictor's goal to maximize the reward obtained through repeated trials (selection of the arm).

In the multi-armed bandit model, a trade-off between the search and the use occurs. In a short term, it is better to operate an arm having a high experience-expected reward at the present time (use of information). However, an event that only a low expected reward is obtained so far unfortunately from an arm of which the proper expected reward is high occurs at a low probability. In order to prevent this, it is necessary to wholly operate all arms (search of information). It is necessary for the predictor to balance the use and the search of information in accordance with a good algorithm. As an algorithm of reward maximization (that is, minimization of regret) that is probabilistic formulation (a probabilistic bandit problem), for example, a UCB (Upper Confidence Bound) algorithm that is a method by a confidence upper bound, a Thompson sampling algorithm that is a method by a posterior probabilistic sample, a MED (Minimum Empirical Divergence) algorithm that is a method by an experience likelihood, and the like are known. The multi-armed bandit problem may be formulated by using each algorithm of discount formulation (a discount bandit problem) or an algorithm of hostile formulation (a hostile bandit problem).

In the UCB algorithm, selection is made by using a UCB value. For an option i, the UCB value is defined by UCBᵢ=Qᵢ+C (≈(2 In (n)/nᵢ)). The Qᵢ is an average value of the reward obtained by selecting the option i, n is the total number of trials, nᵢ is the number of selection trials, and C is a constant (for example, refer to Reference Document 1 (P. Auer, N. Cesa-Bianchi and P. Fischer, “Finite-time analysis of the multiarmed bandit problem”, Machine learning, 47(2), 235-256, 2002)).

In the Thompson sampling algorithm, it is assumed that the average and dispersion of the reward is in accordance with an unknown normal distribution, and a posterior distribution is derived. That is, in accordance with the probability that “an expected value of a reward of an arm is higher than expected values of rewards of any other arms”, the arm is selected. The normal distribution is used for a prior distribution with respect to the average, and a scaled inverse chi-squared distribution is used for a prior distribution with respect to the dispersion. Thereby, the prior distribution becomes a conjugate prior distribution (for example, refer to Reference Document 2 (WR Thompson “On the likelihood that one unknown probability exceeds another in view of the evidence of two samples”, Biometrica, 25 (3-4): 285-294, 1933)).

In the MED algorithm, a consistent estimation parameter is generated with respect to a parameter from current data, it is assumed that the estimation parameter is a true parameter, as a result, the likelihood of an optimal arm arrangement is calculated, the use is performed only when the optimal arrangement can be determined at a significance level of 1=t or less, and otherwise the search is performed (for example, refer to Reference Document 3 (Junya Honda, Akimichi Takemura, “An Asymptotically Optimal Bandit Algorithm for Bounded Support Model”, Machine Learning 85 (2011) 361-391, 2011)).

### (Approach of Reinforcement Learning)

Next, an example of an approach of reinforcement learning is described.

In the machine learning, there is an approach in which the internal reward and the external reward are used for the search and the trial and error while simultaneously considering the internal reward and the external reward. The internal reward is a reward independent of a task and is, for example, rarity of a state, confidence with respect to a state, uncertainty, or the like. The external reward is a reward for solving a given task.

Further, as a method used for calculation of the internal reward, training is performed such that the output difference between a target network that is randomly initialized and fixed and a network of a training target becomes small (for example, refer to Reference Document 4 (Yuri Burda, et al., “EXPLORATION BY RANDOM NETWORK DISTILLATION”, arXiv: 1810. 12894, 2018)).

### (Configuration Example of Reward Calculation Device)

Next, a configuration example of a reward calculation device is described.

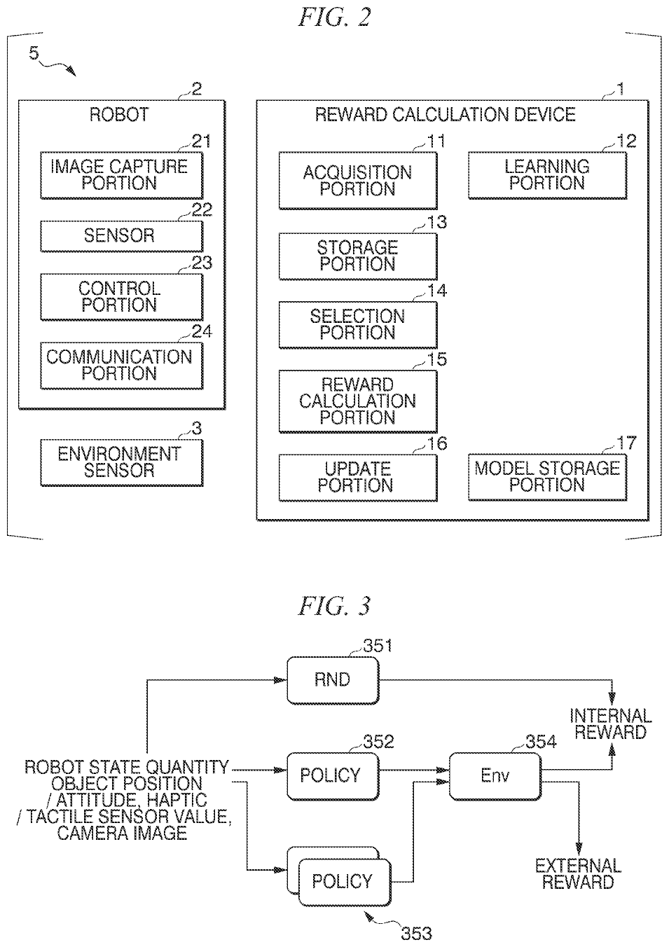

FIG. 2 is a view showing a configuration example of a reward calculation device according to the present embodiment. A reward calculation system 5 includes a reward calculation device 1, a robot 2, and an environment sensor 3.

The reward calculation device 1 includes, for example, an acquisition portion 11, a learning portion 12 (update portion), a storage portion 13, a selection portion 14, a reward calculation portion 15, an update portion 16, and a model storage portion 17.

The robot 2 includes, for example, an image capture portion 21, a sensor 22, a control portion 23, and a communication portion 24.

The image capture portion 21 is attached, for example, to a head portion or a hand of the robot 2.

The sensor 22 is a sensor that detects a position or a posture attached to each joint of the robot, a force sensor or a tactile sensor attached to a finger or a hand, or the like.

The control portion 23 controls a motion of the robot 2.

The communication portion 24 performs transmission and reception of information with the reward calculation device 1 in a wired or wireless manner.

The robot 2 includes an actuator, a drive portion, a storage portion, an electric power source portion, and the like (not shown).

The robot 2 outputs an image captured by the image capture portion 21 and a detection value (the position and the posture of an object, detection values detected by the force sensor and the tactile sensor, or the like) detected by the sensor 22 to the reward calculation device 1 in a wired or wireless manner.

The robot 2 includes a storage portion, an electric power source, a drive portion, and the like (not shown).

The environment sensor 3 is, for example, an RGB (Red, Green, and Blue) D image capture device that can also measure depth information D. The environment sensor 3 is provided, for example, in a range where an image of an object and the robot 2 can be captured. A plurality of environment sensors 3 may be provided. The environment sensor 3 includes a communication portion (not shown).

The acquisition portion 11 acquires a state quantity from the robot 2 and the environment sensor 3. Thereby, the acquisition portion 11 acquires a state quantity of an apparatus that performs a task and a state quantity of a target object to which the task is performed.

The learning portion 12 initializes a model for internal reward calculation, a policy for internal reward calculation, and a policy for an external reward at the time of learning (at the time of training). The learning portion 12 generates an action by probabilistically selecting one from the policy for an external reward and the policy for an internal reward at the time of learning (at the time of training). The learning portion 12 performs one step of the generated action in an environment (a simulation model or an actual machine environment).

The storage portion 13 stores a subset of a state quantity used for the internal reward. The storage portion 13 stores the policy of the internal reward associated with the subset. The subset may be prepared in advance by the reward calculation device 1 or may be prepared in advance by an operator.

The selection portion 14 probabilistically selects a particular subset from the storage portion.

The reward calculation portion 15 calculates the internal reward and the external reward from the subset and the state quantity.

At the time of training, the update portion 16 updates a first policy by using the internal reward and updates a second policy by using the external reward. The update portion 16 updates a selection probability of a subset (hereinafter, referred to as a “state quantity subset”) of a selectable state quantity based on the internal reward and the external reward at the time of searching. The update portion 16 evaluates the external reward which is a reward for solving a task by using a multi-armed bandit model and selects an internal reward used in the external reward having high evaluation. In the present embodiment, the multi-armed bandit model is used by regarding each subset as one slot machine in the multi-armed bandit model.

The model storage portion 17 stores the multi-armed bandit model. The model storage portion 17 stores, for example, a parameter of a kernel function, a parameter of the RND, the first policy, the second policy, and the like.

FIG. 3 is a view showing an outline of a process at the time of training of a manipulation method according to the present embodiment.

The reward calculation device 1 acquires a state quantity (information indicating a position of an object, information indicating a posture of an object, a detection value of a haptic sensor, a detection value of a tactile sensor, an image captured by the image capture portion 21 or the environment sensor 3) from the robot 2 and the environment sensor 3.

In the present embodiment, a subset of selectable state quantity and a combination of subsets are designed in advance and are given. In the present embodiment, each subset is considered to be one of the machines in the multi-armed bandit model and is used. That is, the state quantity used for the internal reward is selected by using the multi-armed bandit model.

Therefore, the subset of the state quantity is input to a RND 351, and the internal reward is calculated. The network of the RND 351 calculates the internal reward by using, for example, the method of Reference Document 4 described above. The calculation of the internal reward may be performed by the kernel method or the like. The RND 351 outputs the internal reward when a contact state is input. For example, when an action aₜ is performed in a state sₜ, only the contact state of the next state sₜ₊₁ that is output by an environment 354 (Env) is input to the RND 351, and the RND 351 calculates the internal reward. The internal reward is calculated, for example, by using a neural network, the kernel method, or the like. The methods used for the calculation of the internal reward include, for example, a method (for example, refer to Reference Document 4 (RND)) in which the parameter of a network of a training target is trained such that an output difference between a neural network of a target in which the parameter is randomly initialized and fixed and a neural network of the training target becomes small. In this method, when the trained data is input, the two networks output similar values, and when unknown data is input, the two networks output different values. Some information of all states is used for the input used for the internal reward. Further, the present embodiment is described using an example in which the RND (Random Network Distillation) is used for the calculation of the internal reward; however, another method may be used.

The first policy 352 is a policy that considers only the external reward. The first policy 352 is trained and updated by the external reward. The acquired state quantity of the robot is input to the first policy 352. The output of the first policy 352 is an action.

The second policy 353 is a policy that considers only the internal reward. The second policy 353 is trained and updated by the internal reward. The acquired state quantity of the robot is input to the second policy 353. The second policy 353 is constituted of N policies associated with N subsets (N is an integer of two or more), respectively. The output of the second policy 353 is an action. The calculation of the external reward differs depending on a set task. For example, in the case of a task that changes the position of an object, the external reward is calculated only from some information (the position of the object) of the state quantity. Further, in the case of another task, the external reward is calculated from all information of the state quantity.

With respect to the update of the first policy 352 and the second policy 353, for example, predetermined times of actions may be performed, the reward of each action may be temporarily stored, and the parameter of the network of the policy may be updated based on an action, for example, at the time of the highest reward among the stored rewards.

The environment 354 (Env) probabilistically selects outputs of the first policy 352 and the second policy 353 and performs an action output by the policy in the environment model. The selection probability is, for example, 40% for the first policy 352 and 60% for the second policy 353. The output of the environment 354 (Env) is only the external reward calculated based on the state quantity of the robot, object information, and contact information.

For example, the environment 354 (Env) outputs the next state sₜ₊₁ and the external reward r^{\hat{ }Ext} when the state sₜ and the action aₜ are input. The environment 354 (Env) outputs the next state sₜ₊₁ and the external reward r^{\hat{ }Ext} even when the action output by the first policy 352 is input or even when the action output by the second policy 353 is input. When the scales output by the first policy 352 and the second policy 353 are different from each other, the outputs are used, for example, by performing normalization such that the ranges of the scales are similar to each other. The output of the environment 354 is the external reward calculated based on the state quantity of the robot, object information, and contact information.

The number of each policy is not limited to one. For example, when there are a plurality of goals, a policy may be provided for each goal. Alternatively, a plurality of goals may be used and input to one policy. That is, the policy may be parallelized or may be used with a goal condition.

The external reward can be stored, and the value of the external reward can be used as is at the time of training. In the case of an on-policy, the internal reward is also temporarily stored, and the value of the internal reward is used as is at the time of training but is discarded after the training. It is determined whether or not the internal reward in the case of an off-policy is rare in consideration of the data experienced so far. Therefore, after the number of data is increased, recalculation is required.

Then, in the training using the external reward, a state sₜ, an action aₜ, an external reward r^{\hat{ }Ext}, and a state sₜ₊₁ after the action are taken out from the model storage portion 17 for a plurality of t, and the parameter of a policy network is updated based on these values.

In the training using the internal reward, a state sₜ, an action aₜ, and a state sₜ₊₁ after the action are taken out from the model storage portion 17 for a plurality of t, an internal reward r^{\hat{ }Int} is recalculated with respect to sₜ₊₁, and the parameter of a policy network is updated based on these values.

In this way, the environment 354 (Env) calculates the external reward. Further, the RND 351 calculates the internal reward. Therefore, for example, the RND 351 and the environment 354 correspond to the reward calculation portion 15. The action of the robot may be simulated by using the environment model, or the motion may be performed by the actual machine. Therefore, the environment may be a simulation environment or may be an actual machine environment.

### (Subset)

Here, an example of a subset is described.

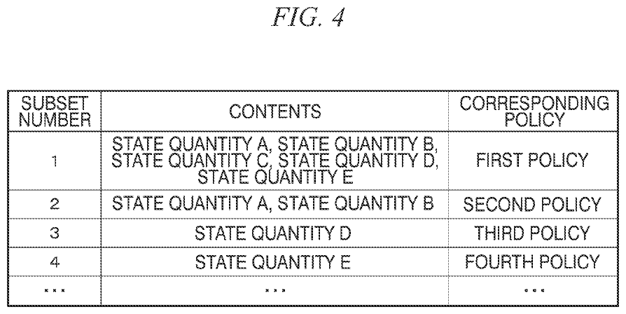

FIG. 4 is a view showing an example of a subset according to the present embodiment. A first subset is, for example, a set of a state quantity A, a state quantity B, a state quantity C, and a state quantity D. A first policy is associated with the first subset. A second subset is a set of the state quantity A and the state quantity B. A second policy is associated with the second subset.

The state quantity A is, for example, information indicating a position of an object. The state quantity B is, for example, information indicating a posture of an object. The state quantity C is, for example, a detection value of the haptic sensor. The state quantity D is, for example, a detection value of the tactile sensor. The state quantity E is, for example, a captured image.

Examples of the combination of subsets, the number of subsets, the state quantity, and the like shown in FIG. 4 are merely examples and are not limited thereto.

### (Process Procedure Example of Reward Calculation Device)

Next, a process procedure example when using the reward calculation device 1 is described.

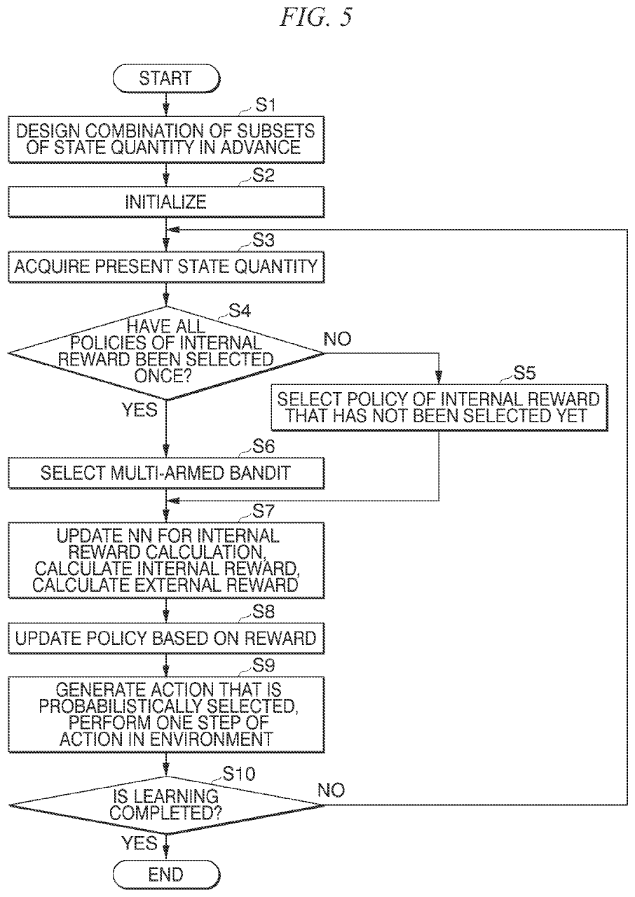

FIG. 5 is a flowchart of a process procedure at the time of learning by the reward calculation device according to the present embodiment.

(Step S1) The learning portion 12 designs subsets of an information amount selectable for calculation of the internal reward and N types of combinations of subsets in advance and stores the subsets and the combinations in the storage portion 13.

(Step S2) The learning portion 12 initializes N models (for example, neural networks: NNs) for internal reward calculation, N policies for internal reward calculation, and a policy for the external reward. The model for internal reward calculation is used only for calculating the internal reward with respect to the subset of the selected information. Further, the policy for internal reward calculation means a network that determines an action on the basis of the internal reward.

(Step S3) The acquisition portion 11 acquires the present state quantity from the robot 2 and the environment sensor 3.

(Step S4) The selection portion 14 determines whether or not all policies of the internal reward have been selected once. The selection portion 14 selects any one from the N subsets and selects a reward for internal reward calculation associated with the selected subset. Further, the selection portion 14 stores how many times a policy has been selected. The selection portion 14 proceeds to a process of Step S6 when all policies of the internal reward have been selected once (Step S4; YES). The selection portion 14 proceeds to a process of Step S5 when there is a policy of the internal reward that has not been selected yet (Step S4: NO).

(Step S5) The selection portion 14 selects the policy of the internal reward that has not been selected yet. The selection portion 14 proceeds to the process of Step S7 after the process.

(Step S6) After all of the N policies are selected, for example, the selection portion 14 performs calculation using the UCB (Upper Confidence Bound) algorithm and, by using the external reward, selects a subset by which the calculation result is maximized and a policy associated with the subset. The external reward is used in the evaluation of the multi-armed bandit. That is, in the present embodiment, evaluation of whether the selection is good or bad for the internal reward is performed by using the external reward, and a subset that is likely to increase the external reward and a policy associated with the subset are selected. In the present embodiment, in the UCB value UCBᵢ=Qᵢ+C (√(2 ln (n)/nᵢ)), the external reward is used for Qᵢ. Further, the option is a subset of the N information described above.

(Step S7) The update portion 16 updates a selected k-th (k is an integer from 1 to N) model for internal reward calculation. The reward calculation portion 15 calculates the internal reward. The reward calculation portion 15 calculates the external reward by using some or all of the state quantities.

(Step S8) The update portion 16 updates the subset and the policy of the internal reward associated with the subset on the basis of the internal reward and updates the policy of the external reward on the basis of the external reward.

(Step S9) The learning portion 12 generates an action by probabilistically selecting either the policy of the external reward or a selected k-th policy of the internal reward. The learning portion 12 performs one step of the generated action in the environment (simulation model).

(Step S10) The learning portion 12 performs, for example, predetermined times of processes and determines whether or not the learning has been completed. The learning portion 12 completes the learning process when it is determined that the learning has been completed (Step S10; YES). The learning portion 12 causes the process to return to Step S3 when it is determined that the learning has not been completed (Step S10; NO).

Here, the process of Step S6 is further described.

The selection portion 14 once tries a series of policies and, as a result, selects a subset associated with a policy that is likely to be good. In this case, the selection portion 14 selects one from a plurality of subsets on the basis of a selection criterion.

Alternatively, the selection portion 14 selects a policy by using the Thompson sampling method. In this case, the selection portion 14 probabilistically selects one from the plurality of subsets.

In this way, in the next loop after a series of policies of the process of Step S6 have been selected and after the first policy has been selected, for example, the first policy becomes a reward that is selected twice, the second policy becomes a reward that is selected once, . . . , in that state, a process in which a policy that maximize the UCB is selected is repeated, and thereby, learning is performed.

Further, in the present embodiment, either a policy of the external reward or a policy (associated with the subset of the internal reward) of the internal reward is probabilistically selected, a generated action is performed, a state quantity of the performed action is acquired, and based on that, the selection criterion of the state quantity subset is updated. That is, the update portion 16 updates the selection criterion of the state quantity subset on the basis of the internal reward and the external reward.

As described above, in the present embodiment, the information amount for calculating the internal reward is selected by the multi-armed bandit model by using the internal reward and the external reward.

Thereby, according to the present embodiment, by automatically selecting the state quantity used for the internal reward while also considering the impact on the external reward for task solution, the internal reward that is not considered in the external reward but is useful for learning of the task solution is selected, and the efficiency of the task solution learning as a purpose is improved.

The above embodiment is described using an example in which the state quantity is acquired from the robot or the robot hand; however, a target from which the state quantity is acquired is not limited thereto. An acquisition target of the state quantity may be an apparatus that solves a task and may be, for example, a vehicle that is automatically operated or the like.

All or some of the processes performed by the reward calculation device 1 may be performed by recording a program for realizing all or some of the functions of the reward calculation device 1 in the embodiment of the present invention on a computer-readable recording medium and causing a computer system to read and execute the program recorded on the recording medium. The “computer system” mentioned here is assumed to include an OS or hardware such as peripheral devices. The “computer system” is assumed to also include a WWW system including a home page-providing environment (or a display environment). The “computer-readable recording medium” is a portable medium such as a flexible disc, a magneto-optical disc, a ROM, or a CD-ROM or a storage device such as a hard disk contained in the computer system. Further, the “computer-readable recording medium” is assumed to include a medium that retains a program for a given time such as a volatile memory (RAM) in a computer system serving as a server or a client when a program is transmitted via a network such as the Internet or a communication circuit such as a telephone circuit.

The program may be transmitted from a computer system that stores the program in a storage device or the like to another computer system via a transmission medium or by transmission waves in a transmission medium. Here, the “transmission medium” that transmits the program is a medium that has a function of transmitting information, such as a network (communication network) such as the Internet or a communication circuit (communication line) such as a telephone circuit. The program may be a program for realizing some of the functions described above. Further, the program may be a program in which the functions described above can be realized in combination with a program which has already been recorded in a computer system, that is, a so-called a differential file (differential program).

Although an embodiment of the present invention has been described, the present invention is not limited to such an embodiment, and various modifications and substitutions can be made without departing from the scope of the present invention.

What is claimed is:

1. A reward calculation device in a learning apparatus that learns by using an external reward which is a reward for solving a given task and an internal reward which is a reward independent of a task, the reward calculation device comprising:
an acquisition portion that acquires a state quantity of the apparatus which performs the task and a state quantity of a target object to which the task is performed;
a storage portion that stores a subset of a plurality of state quantities used for the internal reward;
a selection portion that selects, based on a selection criterion, one from the subset of the plurality of state quantities stored by the storage portion;
a reward calculation portion that calculates the internal reward and the external reward by using the subset and the state quantity; and
an update portion that updates the selection criterion of the subset of the state quantity based on the internal reward and the external reward.

2. The reward calculation device according to claim 1,
wherein the update portion evaluates the external reward by using a multi-armed bandit model and updates the selection criterion so as to select the internal reward used in the external reward having high evaluation.

3. The reward calculation device according to claim 1,
wherein the update portion generates an action of the apparatus by probabilistically selecting one of a policy of the external reward and a policy of the internal reward associated with the subset of the state quantity, acquires the state quantity when the apparatus performs the generated action, and based on an acquired result, the selection criterion, and the external reward, selects a policy of an internal reward associated with the subset of the state quantity used for calculation of the internal reward.

4. The reward calculation device according to claim 1,
wherein the selection criterion is any of a UCB value of a UCB (Upper Confidence Bound) method, a probability in a Thompson sampling method, and a likelihood in a MED (minimum Empirical Divergence) method.

5. The reward calculation device according to claim 2,
wherein the update portion generates an action of the apparatus by probabilistically selecting one of a policy of the external reward and a policy of the internal reward associated with the subset of the state quantity, acquires the state quantity when the apparatus performs the generated action, and based on an acquired result, the selection criterion, and the external reward, selects a policy of an internal reward associated with the subset of the state quantity used for calculation of the internal reward.

6. The reward calculation device according to claim 2,
wherein the selection criterion is any of a UCB value of a UCB (Upper Confidence Bound) method, a probability in a Thompson sampling method, and a likelihood in a MED (minimum Empirical Divergence) method.

7. A reward calculation method of a reward calculation device in a learning apparatus that learns by using an external reward which is a reward for solving a given task and an internal reward which is a reward independent of a task, the reward calculation method including:
by way of an acquisition portion, acquiring a state quantity of the apparatus which performs the task and a state quantity of a target object to which the task is performed;
by way of a storage portion, storing a subset of a plurality of state quantities used for the internal reward;
by way of a selection portion, selecting, based on a selection criterion, one from the subset of the plurality of state quantities;
by way of a reward calculation portion, calculating the internal reward and the external reward by using the subset and the state quantity; and
by way of an update portion, updating the selection criterion of the subset of the state quantity based on the internal reward and the external reward.

8. A computer-readable non-transitory recording medium including a program which causes a computer of a reward calculation device in a learning apparatus that learns by using an external reward which is a reward for solving a given task and an internal reward which is a reward independent of a task to:
acquire a state quantity of the apparatus which performs the task and a state quantity of a target object to which the task is performed;
store a subset of a plurality of state quantities used for the internal reward;
select, based on a selection criterion, one from the subset of the plurality of state quantities;
calculate the internal reward and the external reward by using the subset and the state quantity; and
update the selection criterion of the subset of the state quantity based on the internal reward and the external reward.
